(19) United States
(12) Patent Application Publication
(10) Pub. No.: US 2026/0099301 A1
(43) Pub. Date: Apr. 9, 2026

(54) AUTOMATED CODE GENERATION USING LARGE LANGUAGE MODELS FOR SOFTWARE PLATFORM INTEGRATIONS WITH COMPUTING SERVICES

(71) Applicant: PAYPAL, INC., San Jose, CA (US)

(72) Inventors: Shivani Bayala Banerjee, San Jose, CA (US); Taehee Roy Han, Evanston, IL (US); Laxmikant Sharma, San Ramon, CA (US); Chandra Sekhar Nallam, San Jose, CA (US); Mayank Dandotia, San Jose, CA (US); Mudita Tiwari, Cupertino, CA (US)

(21) Appl. No.: 18/911,167

(22) Filed: Oct. 9, 2024

(51) Int. Cl. G06F 8/30; G06F 8/10

(52) U.S. Cl. CPC G06F 8/30; G06F 8/10

(57) ABSTRACT

There are provided systems and methods for automated code generation using large language models (LLMs) for software platform integrations with computing services. An online transaction processor or other service provider may provide computing services and platforms to entities including merchants for electronic transaction processing and other account services. To provide for conde integrations of the computing services with software platforms of merchants, such as software systems for merchant websites and applications, the service provider may provide for an automated code generation tool that processes data for the software platform and the service to be integrated and provides recommendations and source code. An LLM may be prompted in parts to generate the code after analyzing legacy code from previous integrations and information for the merchant's software platform, and the merchant may be provided new code for testing and implementation.

### TECHNICAL FIELD

The present application generally relates to computing service and software integrations on digital platforms, and more particularly to providing predictive and streamlined processes to integrate computing services on different software platforms.

### BACKGROUND

Online service providers may offer various services to end users, merchants, and other entities. This may include providing computing services through different software applications, websites, platforms, and resources, such as those that may be involved with digital transaction processing. For example, computing services may include those used to process transactions through electronic transaction processing data flows, services, and other computing resources. Further, the service provider may provide and/or facilitate the use of applications and websites for online payments, peer-to-peer (P2P) transfers, and/or marketplaces to different entities including merchants. However, establishment and use of these computing services require merchants and other entities to onboard with the service provider, identify a computing service of interest or need, and integrate those computing services with the merchant external or third-party software platform separate from the service provider. Determining these services and code integrations may not be streamlined and/or may require significant amounts of time in developing, testing, and implementing the computing code and services with different platforms. Further, merchants with legacy computing code and code integrations may not utilize newer, faster, and/or more efficient computing services and resources, leading to inefficient computing systems and wasted resources and processing time. As such, there is a need to provide a more streamlined, faster, and automated process to facilitate the integration of computing services with different computing platforms including transitioning and/or upgrading legacy code integrations to new and improved integrations with better capabilities for computing service execution and usage.

### BRIEF DESCRIPTION OF THE DRAWINGS

FIG. 1 is a block diagram of a networked system suitable for implementing the processes described herein, according to an embodiment;

FIGS. 2A and 2B are exemplary system environments where computing code for computing service integration with software platforms may be generated automatically by prompting an LLM, according to an embodiment;

FIG. 3 is an exemplary diagram of calls between different systems and services when generating code for computing service integration on a software platform using a large language model, according to various embodiments;

FIG. 4 is a flowchart for automated code generation using large language models (LLMs) for software platform integrations with computing services, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for automated code generation using large language models (LLMs) for software platform integrations with computing services. Systems suitable for practicing methods of the present disclosure are also provided.

A user may wish to process a transaction, such as for a payment to another user or a transfer, through an online service provider. The user may pay for one or more transactions using a digital wallet or other account with the online service provider, such as a digital transaction processor (e.g., PayPal®). As such, a merchant may utilize these online service providers for particular computing services, such as to process transactions, create and/or login to accounts with the service provider and/or the merchant, provide risk analysis and/or fraud detection, and other computing services provided through applications, websites, resources, and processors of the service provider. Other service providers may also provide different services to other types of entities, such as computing services for social networking, microblogging, media sharing, messaging, business and consumer platforms, and the like.

As such, the merchant (or other entities) may have software platforms, such as applications and websites, where the merchants may offer their products, services, and other items to users, such as customers and consumers. During the provision of such items, the merchant may desire to incorporate the service provider's computing services within their software platform so that the service may be provided, accessed, and/or linked to on the merchant's platform in place of requiring users to navigate to the service provider's application, website, and/or other platform. In order for merchants to provide the services of the service provider to users for processing transactions with the merchants, the service provider may provide operations for merchants to onboard and setup software and computing code integrations with the service provider through one or more merchant websites, systems, applications, and the like. However, onboarding and integrating code may be cumbersome and time-consuming including upgrading or updating of legacy and outdated code integrations, and without detailed or personalized instructions, merchant may improperly integrate services or forego updating to more current code implementations that utilize more efficient, faster, more secure, and/or improved computing service usage and implementation.

For example, initially during setup of a merchant account and/or platform, merchants may onboard with the service provider to obtain access to accounts and computing services and utilize corresponding services during the course of business or other interactions with customers, clients, and/or entities. This may include accessing computing service setups (including software development kit (SDK) usage and setup, code snippets, and other data for code integrations of the service provider's computing service(s) with the merchant's software platform), application and/or website setup and configuration, and the like. Thus, there are many valid reasons for merchants to drop off from a service provider's onboarding platform, account setup, and/or computing service usage. However, issues with code samples, different code languages, computing environments, and the like may lead to improper integration of complex workflows and processes for computing services. Further, after integrating computing services with merchant platforms, later changes to computing services, code, infrastructure, and the like may require updates, changes, and/or upgrades to the legacy implementations and integrations, such as new code and code packages for service usage with merchant platforms.

Conventionally, merchants and other entities would be required to manually perform code integrations of computing services with software platforms, which is time and labor consuming, and may lead to inefficient or suboptimal solutions, thereby creating computing systems that waste computing resources, processing power, and/or encounter errors and failures. However, a service provider, as discussed herein, may provide an intelligent artificial intelligence (AI) system and engine that may implement machine learning (ML) models, neural networks (NNs), LLMs, and the like for automated code integrations and/or recommendations of legacy code updates and changes to existing integrations. This may be done by prompting an LLM or other generative AI with specific input related to the merchant's platform, legacy integration code (when available), merchant software platform files and code packages, software development documents (SDDs) for the merchant software platform, merchant request payloads, and/or other merchant data payloads. The LLM, once trained for code generation based on a knowledge base, such as corpora of documents for code integrations, may output a code package, file(s), and/or response that includes new code for the new or updated code integration of the computing service(s) of the service provider with the software platform of the merchant.

For example, an LLM or other generative AI and conversational AI engine may include one or more AI models, such as LLMs, ML models, NNs, and/or the like, to converse with merchants, service provider agents assisting merchant with code integrations, and/or other users to determine a personalized and recommended code integration for computing services of the service provider with the software platform of the merchant. These may include generative pretrained transformers (GPTs) including ChatGPT™, Bidirectional Encoder Representations from Transformers (BERT), a Robustly Optimized BERT Approach (RoBERTa), and the like, as well as general purpose or domain specific LLMs. Other types of LLMs and/or generative AIs may also be used, such as one specifically configured for code generation and software integrations. Training of the LLM or other generative AI may be performed using background data for the service provider and/or merchants of the service provider, such as the available computing services and/or products of the service provider, previous code integrations, updates or changes to code and code integrations, legacy code updates to new code, and the like. Further, past onboarding experiences, experience feedback, and/or use or engagement with computing services, products, and the like of the service provider by merchants may be used. During training of the LLM, the model may be trained to make predictions and recommendations of computing code and/or code changes for code integrations. These recommendations may be used to determine new integrations, such as where the merchant may not previously have integrated a computing service with their software platform, as well as update and/or upgrade existing integrations from legacy code and/or code snippets, components, statements, endpoints, etc., to new, more optimized, and/or more efficient integrations and code.

Once trained, the LLM may be deployed to facilitate the onboarding of new merchant customers and the migration existing merchant customers through automated code generation and development. The LLM may be prompted through one or more application programming interface (API) calls, such as through one-shot prompting, few-shot prompting, and/or the like, to generate and/or configure code for a code integration of a computing service with a software platform. Prompting may also be performed based on different LLM or prompting tokens generated for subsets of the data. For example, where the data to be provided to the LLM meets or exceeds a maximum data size or capacity, such as when the LLM is prompted in a conversational manner and the text or characters meets or exceeds the threshold, the data may be split into different subset or groups corresponding to these tokens and the token limits of the LLM.

To prompt the LLM, the selected data may be provided to the LLM with an LLM prompt, such as a statement question, query, request, and/or the like, which may provide an instruction to the LLM with examples or information for executing those instructions and returning a result. Prompt engineering may be performed to create one or more prompt templates that are optimized for best results and return of executable computing code for code integrations and/or code migrations to new integrations, such as new code that may be used in place of old legacy code or where no code exists to provide a computing service of the service provider on another external and/or third-party software platform of a merchant or other entity. The data provided with the prompt may correspond to a payload, such as one including different inputs that may be used by the LLM for code generation and/or updating. For example, a merchant legacy code integration, code files and/or packages, SDD, and/or request payloads may be provided with the prompt and instruction.

The LLM may then generate the code and/or code snippets, samples, classes, API configurations, and the like through intelligent processing using the trained layers, neurons, trees and/or branches, clusters, and/or other ML process. This may be based on training from a set of documents, samples, and/or the like. The output of the LLM may therefore correspond to a code data package, which may be output and/or transmitted to a particular platform or service that may be utilized by the merchant for code configuration, writing, reviewing, and/or testing. Code generation may be performed by the LLM from code transformations and the like and may be performed in a particular code language and specification required by the merchant's software and framework. The merchant may also specify particular API configurations and endpoints for use, which may include migration from legacy API configurations and endpoints to new ones that facilitate improved performance.

As such, the automated code generation AI system may leverage and utilize specifically trained LLMs and other generative AIs or ML techniques and modes to provide a more convenient and personalized computing code onboarding and/or migration system. The AI system may therefore provide merchants and other entities with automated code generation processes that may remove or limit the manual efforts for code development, simplifying processes and providing more streamlined, efficient, and optimized computing code for improved performance and usage of new computing configurations and resources. This allows for coordinated communications with merchants and merchant software platforms to facilitate the incorporation of computing code for different computing service on such platforms.

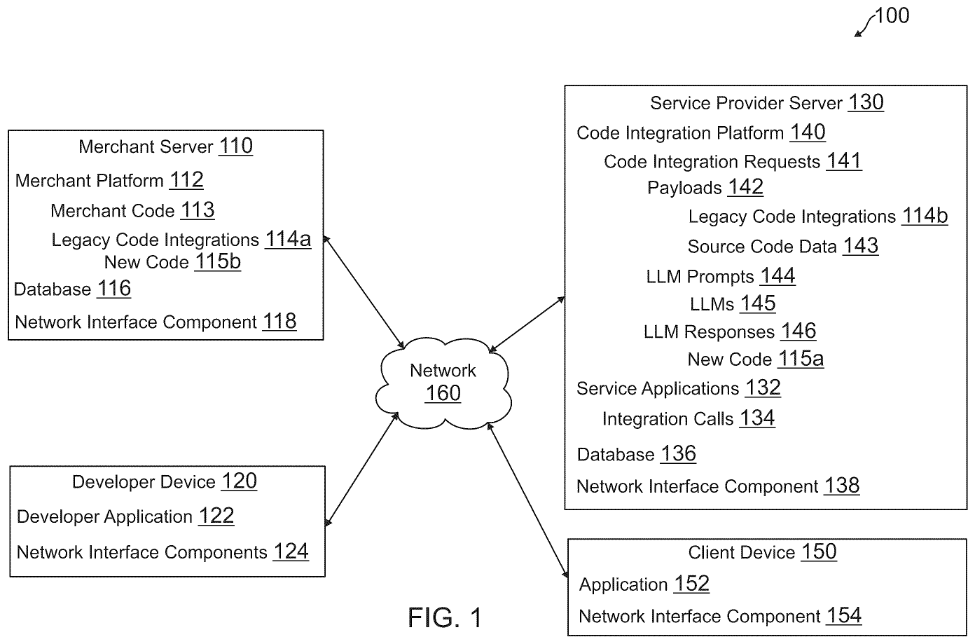

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, and/or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a merchant server 110, developer device 120, a service provider server 130, and client device 150 in communication over a network 160. Merchant server 110 may be utilized by a merchant or other user to provide a merchant platform 112 over network 160 to client device 150. Service provider server 130 may provide various data, operations, and other functions over network 160 to provide services to merchants, users, and computing devices. In this regard, merchant server 110 may be used to onboard software platforms of merchant server 110 with service provider server 130, incorporate the services of service provider server 130 on such platforms, and/or migrate existing platform to and/or update using new code and code integrations. Service provider server 130 may provide streamlined and personalized operations for code generation and migration using intelligent operations and systems, such as through the use of LLMs and the like. Once configured with integrated computing services, client device 150 may then interact with merchant platform 112 and utilize those computing services.

Merchant server 110 and service provider server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Merchant server 110 may be maintained, for example, by a merchant that may utilize merchant platform 112 to provide products to users, such as items and services for sale, which may be browsed and purchased through an online digital platform and via computing devices including client device 150. In this regard, merchant server 110 may provide merchant platform 112 through a native software application and/or website and browser applications. Merchant platform 112 may offer products to users, such as items and services for sale, which may utilize the computing services of service provider server 130 through computing code integrations. Merchant server 110 may therefore provide merchant platform 112 to client device 150 for engagement with the merchant's products and use of integrated computing services, as discussed herein. In one example, merchant server 110 may be provided by a merchant or multiple merchants including a merchant marketplace provider that allows multiple merchants to offer products for sale. However, in other embodiments, merchant server 110 may correspond to another type of entity that may have and/or utilize a software platform accessible via a native software application and/or a browser application of the client devices for users to access and view data, as well as engage with integrated computing services of service provider server 130.

Merchant server 110 of FIG. 1 includes and/or is associated with merchant platform 112, a database 116, and a network interface component 118, implementations of which are discussed further below. The merchant platform 112 may correspond to executable processes, procedures, and/or applications with associated hardware. In other embodiments, merchant server 110 may include additional or different modules having specialized hardware and/or software as required.

Merchant platform 112 may correspond to one or more processes to execute software modules and associated components of merchant server 110 to provide features, services, and other operations by a merchant for customers, which may include merchant sales operations, POS device processing and/or operations, online merchant marketplaces, sales and inventory services, and the like. For example, merchant platform 112 may correspond to a software platform where computing services of service provider server 130 for use of a merchant account, payment and/or electronic transaction processing services, and the like may be provided to the merchant's customers. In some embodiments, the computing services of service provider server 130 implemented and integrated with merchant platform 112 may further include processes for merchant sales, inventory, return or exchange, risk analysis, and other services a merchant may require during the course of their business and sales, such as to provide, market, and/or sell products, services, and other items to customers and/or assist customers with purchases.

In this regard, merchant platform 112 may correspond to a specialized and/or specifically configured software platform utilized by a merchant or other user of merchant server 110 to provide applications, websites, resources, and data based on the account and/or computing services enabled by service provider server 130 for the merchant. Merchant platform 112 may provide and/or process items for sale with merchant server 110 and/or a user interacting with merchant server 110 (e.g., using a POS device, the website, mobile application, and/or another merchant marketplace platform. In certain examples, merchant platform 112 may be accessible over the Internet and provide for sales with merchant server 110 over network 160.

In some embodiments, merchant platform 112 may correspond to and/or be used to configure a checkout application at a physical merchant location, such as the application(s) of a point-of-sale (POS) device used to provide sales at physical locations. For example, merchant platform 112 may be used to establish a transaction once a user/employee associated with merchant server 110 has selected one or more items for purchase and/or entered the item(s) to the transaction for processing. Once a payment amount is determined for the item(s) to be purchased by the user, merchant platform 112 may request payment for the transaction. Payment may be provided using electronic transaction processing services enabled and/or provided by service provider server 130 after incorporating and/or integrating computing services of service provider server 130 using an intelligent code integration and/or migration platform and AI system, as discussed herein. In this regard, payment may be received from a user and may be processed using service provider server 130. After receipt of payment and/or confirmation of the payment, merchant platform 112 may then process a payment to the merchant associated with merchant server 110.

In some embodiments, merchant platform 112 may be used to host, provide, and/or access and maintain a website of the merchant, a web-based application, and/or the like, which may also be configured based on computing services provided by service provider server 130. The website may be operated, hosted, updated, and provided to end user devices and other systems or servers. The website may correspond to a hosted website having webpages that may include parent and child webpages where customers and service providers may browse items and other services provided by a corresponding merchant, engage in electronic transaction processing, provide customer support and feedback, and the like. The website may be provided through one or more webpages having of Hypertext Markup Language (HTML) code, Extensible Markup Language (XML) code, JavaScript code, and/or Cascading Style Sheets (CSS). In other embodiments, merchant platform 112 may provide data for an application that may be installed on client devices of users and used to access the merchant's data, marketplace, items, and the like, as well as use the computing services of service provider server 130 through such application.

Merchant platform 112 may be provided using merchant code 113, which may correspond to computing code, files, packages, resources, APIs and endpoints, and the like that may be used during data calls and platform provision to different client devices of users. Merchant code 113 may have certain parameters or properties, including a code language, specifications, code packages or lines of executable code, and the like, which may be specified in code files, API specifications, SDDs, and the like. Website data for the website, as well as the aforementioned applications and application data, may be configured using code intelligently generated by service provider server 130, for example, using installed and/or configured code snippets, code packages, SDKs and SDK operations, APIs and endpoints, and the like. This may correspond to legacy code integrations 114a for the computing services of service provider server 130 on or with merchant platform 112. For example, website data may include HTML code with for API calls to APIs associated with service applications 132, which may be configured for code integrations. Legacy code integrations 114a may also or instead be associated with native application data for one or more applications on client device 150. As such, legacy code integrations 114a may correspond specifically to those integrations with merchant platform 112. However, legacy code integrations 114a may be required to be updated to newer and/or more optimized specifications, such as through code migrations to new platforms, services, and/or executable code, which may be provided through new code 115b received from service provider server 130 from an LLM response or output based on legacy code integrations 114a and other updates or changes to code integrations. As such, legacy code integrations 114a and new code 115b may be generated by prompting an LLM, as discussed herein, based on the code configurations, specifications, SDDs, and the like for merchant platform 112.

In this regard, service provider server 130 may streamline code integration and migration services for code implementation and updates, such as by providing application data, application interfaces and interface elements, website capabilities, website layouts, and the like through an AI platform. The application and/or website may further be updated when or after the merchant is onboarded and/or implements code in order to update the computing service capabilities of service provider server 130 with the application and/or website (e.g., payment functionalities, as well as other integrated operations and/or SDKs). As such, the merchant may provide merchant platform 112 via a website, application, and/or the like to end users, which may be configured to use the computing services, SDKs and SDK operations, APIs and endpoints, and the like provided by service provider server 130.

Merchant platform 112 may be accessible by users via a general browser application and/or general, native, and/or local mobile application configured to retrieve, present, and communicate information over the Internet (e.g., utilize resources on the World Wide Web) or a private network. For example, merchant platform 112 may correspond to a website accessible via a web browser, which may send and receive information over network 160, including retrieving website information (e.g., a website for an email provider or other messaging service), presenting the website information to the user, and/or communicating information to the website. Merchant platform 112 may instead correspond to application data accessible via a dedicated software application provided by the merchant or other entity. Merchant platform 112 may be associated with digital payment accounts, account information, user financial information, and/or transaction histories, which may be associated with electronic transaction processing services provided by service provider server 130 for merchants.

Merchant server 110 may further include or have access to a database 116, which may correspond to different types of data storage and components including cloud computing storage nodes, remote data stores and database systems, distributed database systems over network 160, and the like used to store various applications and data.

Database 116 may include, for example, identifiers such as operating system registry entries, cookies associated with merchant platform 112 and/or other applications, identifiers associated with hardware of merchant server 110, and/or other appropriate identifiers, such as identifiers used for payment/user/device authentication or identification, which may be communicated as identifying the merchant and/or merchant server 110 to service provider server 130.

Merchant server 110 includes at least one network interface component 118 adapted to communicate with service provider server 130 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Developer device 120 may be implemented as a communication device that may utilize appropriate hardware and software configured for wired and/or wireless communication with merchant server 110 and service provider server 130 over network 160. For example, in one embodiment, developer device 120 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Developer device 120 of FIG. 1 includes and/or is associated with a developer application 122 and a network interface component 124, implementations of which are discussed further below. The developer application 122 may correspond to executable processes, procedures, and/or applications with associated hardware. In other embodiments, developer device 120 may include additional or different modules having specialized hardware and/or software as required.

Developer application 122 may correspond to one or more processes to execute software modules and associated components of developer device 120 that may be utilized by a merchant to access the features, services, and platforms provided by service provider server 130. Developer application 122 may be used for development of software platforms of the merchant and integration of the software platforms with the computing services provider by service provider server 130. For example, developer application 122 may correspond to a browser application or native software application that may be utilized to configure a merchant platform 112 on merchant server 110 and/or access a code integration platform 140 on service provider server 130 for use with configuring merchant platform 112. During use of developer application 122, one or more interfaces may be presented to a developer or other user of the merchant, which may be used to access and view a corresponding website or application of code integration platform 140 associated with service provider server 130. The interfaces may enable the developer to engage in development of merchant platform 112 and integration of computing services of service provider server 130 with merchant platform 112 via code integration platform 140 of service provider server 130. In this regard, the interfaces may display options, suggestions, recommendations, and/or other information for integrations and/or migrations of legacy integrations of computing services and API calls with merchant platform 112 to new integrations, code, APIs and API call structures or parameters, and the like. Such dynamically configured code and presentations of data may include configured code snippets, code packages, SDKs and SDK operations, APIs and endpoints, and the like.

Developer application 122 may be accessible by users via a general browser application and/or general, native, and/or local mobile application configured to retrieve, present, and communicate information over the Internet (e.g., utilize resources on the World Wide Web) or a private network. For example, developer application 122 may correspond to a website accessible via a web browser, which may send and receive information over network 160, including retrieving website information (e.g., a website for an email provider or other messaging service), presenting the website information to the user, and/or communicating information to the website. Developer application 122 may correspond to application data accessible via a dedicated software application provided by the merchant or other entity. Developer application 122 may be associated with merchant accounts and account information for products of service provider server 130 used by the merchant and/or on merchant platform 112, account information, user financial information, and/or transaction histories, which may be associated with electronic transaction processing services provided by service provider server 130 for merchants.

Developer device 120 includes at least one network interface component 124 adapted to communicate with merchant server 110, service provider server 130, and/or other devices and servers. In various embodiments, network interface component 124 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 130 may be maintained, for example, by an online service provider, which may provide computing services and operations via one or more digital platforms, applications, websites, and the like. Service provider server 130 may provide computing services to various entities, which may require onboarding for account and service usage. In one example, service provider server 130 may be provided by PAYPAL®, Inc. of San Jose, CA, USA. However, in other embodiments, service provider server 130 may be maintained by or include another type of service provider.

Service provider server 130 of FIG. 1 includes and/or is associated with code integration platform 140, service applications 132, a database 136, and a network interface component 138, implementations of which are discussed further below. Code integration platform 140 and service applications 132 may correspond to executable processes, procedures, and/or applications with associated hardware. In other embodiments, service provider server 130 may include additional or different modules having specialized hardware and/or software as required.

Code integration platform 140 may correspond to one or more processes to execute modules and associated specialized hardware of service provider server 130 to provide an AI platform that may utilize LLMs, generative AIs, and/or other ML models for automated code generation and migration for merchant with the computing service associated with service applications 132 of service provider server 130. In this regard, code integration platform 140 may correspond to specialized hardware and/or software used by a merchant or other user associated with merchant server 110 to provide operations during onboarding and/or code migration of merchant platform 112 with the computing services of service provider server 130 provided through service applications 132. For example, code integration platform 140 may receive code integration requests 141 for integrating different software platforms with the computing services provided by service provider server 130, such as a merchant onboarding request, computing service usage request, and/or code migration request for computing resources provided by service provider server 130. Based on this request, code integration platform 140 may provide an AI engine to process code integration requests 141 and generate computing code, such as new code for a new integration and/or a code migration of legacy or previously used code.

As such, code integration platform 140 may generate data for processing to determine code recommendations, new code samples or blocks of code, and the like, which may be used to respond to code integration requests 141 with computing code that facilitates integration of merchant software platforms with computing services provided through service applications 132. In this regard, code integration requests 141 may be processed to determine payloads 142 for processing by an AI engine, such as one or more LLMs or other generative AIs. Payloads 142 may include legacy code integrations 114b from data received from merchant server 110, including information for legacy code integrations 114a implemented on merchant platform 112, as well as data for other merchant servers for past or legacy code integrations that may be available for merchant software platforms, as well as source code data 143. Legacy code integrations 114b and/or source code data 143 may include code files for the merchant software platform (e.g., previous code files for legacy, past, and/or currently used code integrations, which may be designated for updating, upgrading, and/or migrating to newer code), SDDs, request payload samples or structures, contexts for code integrations and/or service usage, and the like. Code files may be provided directly, such as in one or more uploadable/downloadable files, a compressed file (e.g., a .zip file), and/or the like, or may be linked to a code repository platform (e.g., GITHUB®). Payloads 142 may be processed to determine computing code (e.g., blocks, files, snippets, samples, etc.), SDKs, API endpoints for system integrations, and the like for integrating computing services with merchant platforms 112.

To generate code, LLM prompts 144 may be used with payloads 142 to prompt LLMs 145. LLM prompts 144 may correspond to instructions, such as text instructions and/or API calls to LLMs 145, that may be used with the data from payloads 142 to prompt LLMs 145 and request LLM responses 146 from LLMs 145. For example, the instructions of LLM prompts 144 may correspond to instructions to LLMs 145 to generate code by using samples from payloads 142, as well as the training and knowledge base of LLMs 145, to determine code that may be used to integrate the computing services of service applications 132 with merchant platform 112. LLM prompts 144 may include and/or be associated with prompting strategies that may be used to prompt LLMs 145 through different questions, statements, calls, and the like (e.g., zero, one, and/or few-shot call prompting, question-and-answering prompting, chain-of-thought prompting, etc.).

Further, LLM prompts 144 may also correspond to different types of code to be generated, such as code for different types of services and/or processing flows for the computing service. For example, LLMs 145 may have different token limits, such as a limit on data size, a number of characters in a text request and prompt, and the like, which may limit the amount of data provided through payloads 142 and LLM prompts 144 in a single request or call. As such, payloads 142 may be separated into different code sections and “tokens” based on the token limits and code sections or services to be generated for code integrations of services. These may include an authentication service, backend including order service and/or API service(s), one or more UIs, code dependencies on different resources or services, unit tests to verify other blocks of code, and the like.

LLMs 145 may then be prompted to provide code based on payloads 142 and LLM prompts 144. Code integration platform 140 may train and utilize LLMs 145 that execute one or more deep learning models, AI or ML models, NNs and/or deep NNs (DNNs), conversational AIs, and/or the like for general or specialized (e.g., domain-specific, such as code generation-specific) purpose language generation. LLMs 145 may have trained layers based on training data and selected features or variables configured to generate conversation or dialogue with merchants during onboarding. For example, ML features or variables may correspond to individual pieces, properties, characteristics, and/or other inputs for an ML model and may be used to cause an output by that ML model once the ML model has been trained using data for those features from training data. LLMs 145 may be used for language generation through deep learning or other ML models based on layers, nodes, branches, clusters, rules, and the like that are trained and optimized. As such, ML models may be trained to provide a predictive output of responsive language and/or language generation, such as a text response and/or automatically generated computing code.

For example, LLMs 145 may include DNNs, MLs, LLMs, generative AIs, and/or other AI models trained using training data having data records that have columns or other data representations and stored data values (e.g., in rows for the data tables having feature columns) for the features. When building LLMs 145, training data may be used to generate one or more classifiers and provide recommendations, predictions, and/or other outputs based on those classifications and an ML or NN model algorithm and architecture. The algorithm and architecture for the LLMs 145 may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

For example, DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, and/or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values include language generation. Thus, when the LLMs 145 are used to perform a predictive analysis and output of language generation, the input data may provide a corresponding output based on the trained classifications.

Layers, branches, clusters, and/or the like of the LLMs 145 may be trained by using training data associated with data records of interest, such as computing code, code specifications or development documents, API and API call structures or API specifications, previous code integrations, and the like. By providing training data, the nodes in the hidden layer may be trained (adjusted) such that an optimal output (e.g., a classification) is produced in the output layer based on the training data. By continuously providing different sets of training data and/or penalizing the LLMs 145 when the outputs are incorrect, the LLMs 145 (and specifically, the representations of the nodes in the hidden layer) may be trained (adjusted) to improve its performance in data classifications and predictions. Adjusting of the LLMs 145 may include adjusting the weights associated with each node in the hidden layer.

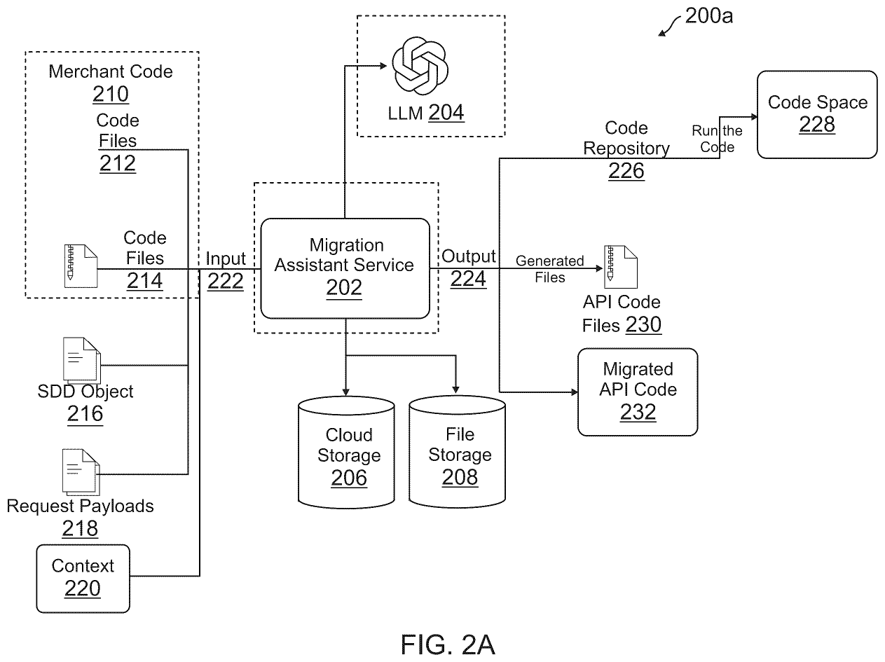

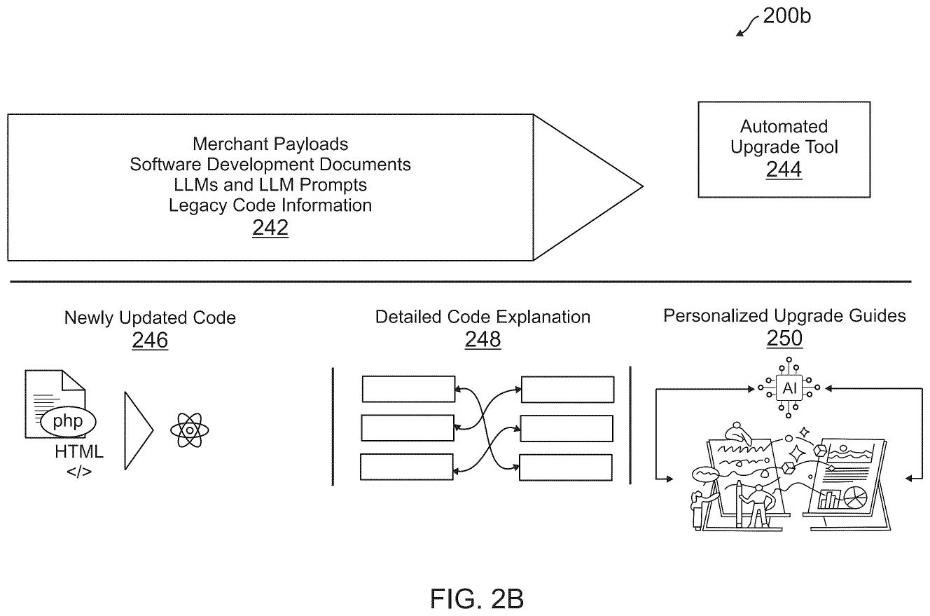

LLM responses 146 may output new code 115a to merchants or other users via one or more user interfaces presentable via user devices, on different computing platforms, and/or in different computing environments. For example, new code 115a may be generated by LLMs 145 at service provider server 130, where developer device 120 may be used to implement new code 115b, such as a specific integration update or migration from new code 115a, with merchant platform 112 on merchant server 110. New code 115a may include outputs by LLMs 145 that may include new source computing code that integrates computing services of service applications 132 with merchant platform 112. A chat session and/or chat assistant may present new code 115a to the merchant. However, in other embodiments, the data may be stored on and/or transmitted to another computing environment and/or platform for review, testing, implementation, and the like by the merchant. The operations for computing code generation and provision of new code 115a for use with merchant platform 112 are discussed in further detail with regard to FIGS. 2A-4 below.

Service applications 132 may correspond to one or more processes to execute modules and associated specialized hardware of service provider server 130 to process a transaction and/or provide other computing services to users. For example, service applications 132 may be used to process payments and other services to one or more users, merchants, and/or other entities for transactions, where merchants may integrate use of one or more of service applications 132 through generation of new code 115a by code integration platform 140. In this regard, service applications 132 may be used to send and receive payments, including those payments that may be enabled through the website and/or application corresponding to merchant platform 112 after integrating use of those services through code generation and/or migration by code integration platform 140. A payment account for use of these services may be accessed and/or used through a browser application and/or dedicated payment application, such a payment and/or digital wallet application. Service applications 132 may process payments and may provide transaction histories to merchant server 110 and/or another user's device or account for transaction authorization, approval, or denial of the transaction for placement and/or release of the funds, including transfer of the funds between accounts.

Further, service applications 132 may provide different computing services, including social networking, microblogging, media sharing, messaging, business and consumer platforms, etc. These computing services may be used by customers and users, such as through user devices, and may be implemented on different merchant platforms, websites, and/or applications. For example, merchant platform 112 may implement one or more of the computing services of service applications 132 and may call those services using those integrations through integration calls 134. Integration calls 134 may be used to process data with merchant platform 112 and provided requests and responses for data processing.

Service applications 132 may provide additional features to service provider server 130. For example, service applications 132 may include security applications for implementing server-side security features, programmatic client applications for interfacing with appropriate application programming interfaces (APIs) over network 160, and/or other types of applications. Service applications 132 may contain software programs, executable by a processor, including one or more GUIs and the like, configured to provide an interface to the user when accessing service provider server 130, where the user or other users may interact with the GUI to view and communicate information more easily. Service applications 132 may include additional connection and/or communication applications, which may be utilized to communicate information to over network 160.

Additionally, service provider server 130 includes or may access database 136. Database 136 may store various identifiers associated with merchant server 110, developer device 120, and/or client device 150. Database 136 may also store account data, including payment instruments, financial information, account balances, and authentication credentials, as well as transaction processing histories and data for processed transactions. Database 136 may include information used during merchant onboarding. Although database 136 is shown as residing on service provider server 130 as a database, in other embodiments, other types of data storage and components may be used including cloud computing storage nodes, remote data stores and database systems, distributed database systems over network 160 and/or of a computing system associated with service provider server 130, and the like.

Service provider server 130 may include at least one network interface component 138 adapted to communicate merchant server 110, developer device 120, client device 150, and/or other devices and servers over network 160. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Client device 150 may be implemented as a computing device of a user, such as a consumer or a customer of a merchant associated with merchant server 110, that may utilize appropriate hardware and software configured for wired and/or wireless communication with merchant server 110 and/or service provider server 130. For example, client device 150 may be utilized by a consumer to access merchant platform 112 to browse items for sale and engage in electronic transaction processing. Client device 150 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly, such as those of a plurality of consumers engaging in shopping and purchasing from the merchant via merchant platform 112.

Client device 150 of FIG. 1 contains an application 152 and a network interface component 154. Application 152 may correspond to executable processes, procedures, and/or applications with associated hardware. In other embodiments, client device 150 may include additional or different modules having specialized hardware and/or software as required.

Application 152 may correspond to one or more processes to execute software modules and associated components of client device 150 to provide features, services, and other operations for a user, which may include accessing merchant platform 112 and/or engaging in use of computing services provided by service provider server 130 via merchant platform 112. In this regard, application 152 may correspond to software utilized by a user of client device 150 to access a website or application data (e.g., for a mobile application, rich Internet application, or resident/native software application) that may display one or more UIs that allow for interaction with merchant platform 112, for example, to browse items for sale, select and/or checkout for items, process transactions electronically (e.g., perform electronic transaction processing for items, send/receive payments, etc.), login to accounts, and/or receive receipts and transaction histories. Thus, application 152 may display data for merchant platform 112 that allows the user to interact with merchant platform 112 via the UI(s) displaying data for the merchant's items for sale, offers, advertisements, and other information on merchant platform 112. Application 152 may enable the use integrated computing services for service applications 132 of service provider server 130 on merchant platform 112. As such, in various embodiments, application 152 may correspond to a general browser application configured to retrieve, present, and communicate information over the Internet (e.g., utilize resources on the World Wide Web) or a private network. However, in other embodiments, application 152 may include a native and dedicated application associated with merchant server 110, service provider server 130, and/or another entity that may access data for and/or present merchant platform 112 on client device 150.

Application 152 may be associated with account information, user financial information, and/or transaction histories for electronic transaction processing, including processing transactions using financial instrument or payment card data on merchant platform 112 using legacy code integrations 114a for integrated computing services, which may be updated by new code 115b, as discussed herein. Application 152 may be utilized to enter, view, and/or process items the user wishes to purchase in a transaction, as well as perform peer-to-peer payments and transfers, using the integrated computing services. A payment may be requested to be made on merchant platform 112 using the integrated services, and application 152 may be used to specify user financial information, such as credit card data, bank account data, or other funding source data, as a payment instrument when providing payment information to service provider server 130. Additionally, application 152 may utilize a digital wallet associated with an account with a payment provider as the payment instrument, for example, through accessing a digital wallet or account of a user through entry of authentication credentials and/or by providing a data token that allows for processing using the account. Application 152 may receive a receipt or other information based on transaction processing of the transaction. In some embodiments, additional services may be provided via application 152, including social networking, media posting or sharing, microblogging, data browsing and searching, online shopping, and other services available through service provider server 130.

Client device 150 includes at least one network interface component 154 adapted to communicate with merchant server 110, service provider server 130, and/or another device or server. In various embodiments, network interface component 154 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

FIGS. 2A and 2B are exemplary system environments 200a and 200b where computing code for computing service integration with software platforms may be generated automatically by prompting an LLM, according to an embodiment. System environments 200a and 200b may include components of service provider server 130 that may be utilized by merchant server 110 for merchant code integrations, such as to generate code to implement computing services during a code usage and/or migration, as discussed in reference to system 100 of FIG. 1. In this regard, system environments 200a and 200b may correspond to a production computing environment where code integration platform 140 executes one or more operations.

Referring now to system environment 200a of FIG. 2A, an embodiment of code integration platform 140 that may provide a migration assistant service 202 for a conversational AI and/or code generation service is shown. Migration assistant service 202 may utilize an LLM 204, such as one of LLMs 145 that may be prompted based on payloads 142 using LLM prompts 144 from system 100, in order to provide code generation for code implementation and/or migration when integrating computing services of a service provider with a software platform of a merchant. As such, migration assistant service 202 may correspond to an implementation of LLMs 145 used for generative AI services and code generation provided by code integration platform 140. LLM 204 may correspond to one of LLMs 145, which may be an AI model trained for outputting code integrations by procedurally generating computing code for code integrations, such as when newly implementing a computing service and/or migrating a previous integration of a computing service to new code, APIs, and/or other code and/or computing system specifications and components. Migration assistant service 202 may access a cloud storage 206 for retrieving and/or storing different code data including source code, previous or legacy code integrations, SDDs, and the like, as well as a file storage 208 that may store data files for computing code (e.g., code blocks, snippets, documents, etc.). In this regard, cloud storage 206 and file storage 208 may be utilized by merchants and/or the service provider to access and/or retrieve code and code samples when prompting LLM 204, as well as to store code generated automatically by LLM 204.

Initially, a merchant may request a new code integration, such as to use a computing service of the service provider and/or migrate code from a previous integration and uses of the service to new code, APIs, computing environments or systems, and the like. As such, the merchant may provide different data files, packages, links, and the like for legacy computing code of legacy integrations, source code for software platforms, and the like. The merchant may provide merchant code 210 through code file links 212 and/or compressed code files 214, which may allow migration assistant service 202 to access and parse source code for the merchant's software platform. Merchant code 210 may correspond to legacy code integrations 114b used by code integration platform 140 when generating new code 115a using LLMs 145. In addition to merchant code 210, the merchant may provide an SDD object 216, such as a file or link to an SDD for the software platform of the merchant, request payloads 218 for API requests and/or other API calls, and/or context 220 for a context of computing service usage on the software platform of the merchant. In this regard, merchant code 210, SDD object 216, and/or request payloads 218 may correspond to payloads 142 used to prompt LLMs 145 using LLM prompts 144 from system 100.

Migration assistant service 202 may the process input 222 from merchant code 210, SDD object 216, request payloads 218, and context 220 using LLM 204 to provide an output 224. Output 224 may correspond to code automatically generated by LLM 204 based on training data and a knowledge base, as well as code analysis and predictive AI generation using one or more deep learning models or the like. For example, output 224 may correspond to LLM responses 146 having new code 115a that may be used for new code integrations. Outputs 224 may therefore correspond to code blocks, snippets, files, and/or the like, and may include multiple outputs for different code sections that may be combined into a code package for review and/or use by the merchant. Outputs 224 may be loaded into different computing systems and/or environments, as well as transmitted to the merchant and/or output via one or more user interfaces. For example, a code repository 226 may receive the code for output 224 and run in a code space 228 for analysis and/or testing. API code files 230 may also be provided for API testing and/or integration, as well as migrated API code 232 for migrations of legacy API code to newer APIs and API code.

Referring now to system environment 200b of FIG. 2B, an embodiment of the data flow from processing a request for a code integration and/or migration to outputting new code for that integration and/or migration by code integration platform 140 is shown. System environment 200b may represent a data flow of input 222 for migration assistant service 202 to output 224 by migration assistant service 202 based on code generation performed using LLM 204. Such code generation may be performed when initially onboarding and/or integrating a computing service of a service provider with a software platform of a merchant, or may be performed when migrating, old, previous, and/or legacy computing code with the software platform to new code, APIs and API specifications, and the like. A data set 242 may be provided to an automated upgrade tool 244, such as an AI system and service that relies on a knowledge base to provide a conversational and generative AI, such as through one or more LLMs, to merchants may be used for generating computing code integrations of computing services with software platforms. As such, automated upgrade tool 244 may be used to assist merchants with onboarding, implementing, and/or migrating their computing software and software platform with the usage of computing services provided by a service provider, such as by generating merchant and software-platform specific computing code. To do so, data set 242 may include a payload of data from the merchant and LLM prompts, such as merchant payloads for requests or other API calls, SDDs, LLM designations and LLM prompts for such LLMs and code integration generation, and legacy code information (e.g., source code and/or legacy code integrations). The knowledge base for automated upgrade tool 244 may be associated with data and resources used for computing service integrations and code generation.

As such, automated upgrade tool 244 may utilize a conversational AI and/or LLMs to generate code from input requests and prompts, such as LLM 204 from FIG. 2A. An input prompt may be received for automated upgrade tool 244, which may correspond to a request and one or more components of data set 242. For example, one or more LLM prompts may be updated and/or utilized with portions of the data and/or computing code from merchant request payloads, SDDs, and/or legacy code information to prompt LLM 204 and request LLM 204 generate code from the code samples and code information for the software platform. Prompting may include promoting by parts, such as prompting through multiple calls and different prompts and/or payloads to comply with token limits, such as a character and/or data size limit, for input to LLM 204 and/or other conversational AIs. As such, each prompt may correspond to a different portion of code to be generated, for example for different computing operations (e.g., authentication, order service, API services, UIs, code dependencies on different resources or services, unit tests, etc.).

Newly updated code 246 may be output by automated upgrade tool 244. Newly updated code 246 may be provided in a data file or the like having computing code blocks and/or snippets used for implementing the computing service of the service provider on or with the software platform of the merchant. Newly updated code 246 may be transmitted in the files to the merchant and/or may be uploaded to another platform or computing environment for review, processing, and/or testing. With newly updated code 246, detailed code explanations 248 may be provided by LLM 204, which may include explanations of the code portions generated and how the code can be implemented for code integration and/or migration of the computing service. As such, newly updated code 246 and detailed code explanations 248 may be provided with personalized upgrade guides 250 to the merchant to personalize an upgrade, integration, and/or migration process of computing services. Personalized upgrade guides 250 may include the new computing code and instructions for implementing the new computing code with the merchant's software platform for computing service integration and/or migration to new APIs and/or API and code specifications required for updated computing systems and software.

After processing using an AI engine and trained models, such as migration assistant service 202 that may utilize LLM 204, an output may be provided to the merchant during onboarding. In this regard, a response may be formulated as a conversational dialogue that may provide a merchant-specific recommendation to the merchant. A response validation service 254 may be used to validate the response, which may utilize validation data 255 including internal content sources, eligibility terms of services, products, and/or offers, and/or insights and trends to service and product usage. As such, validation data 255 may further be used to tailor or adjust the recommendation by response validation service 254. Thereafter, an output response 256 may be provided to the merchant, which may correspond to the merchant-specific recommendation provided via a chat, dialogue, or the like, notification or message in a user interface, or the like that may be provided during an onboarding or account lifecycle event.

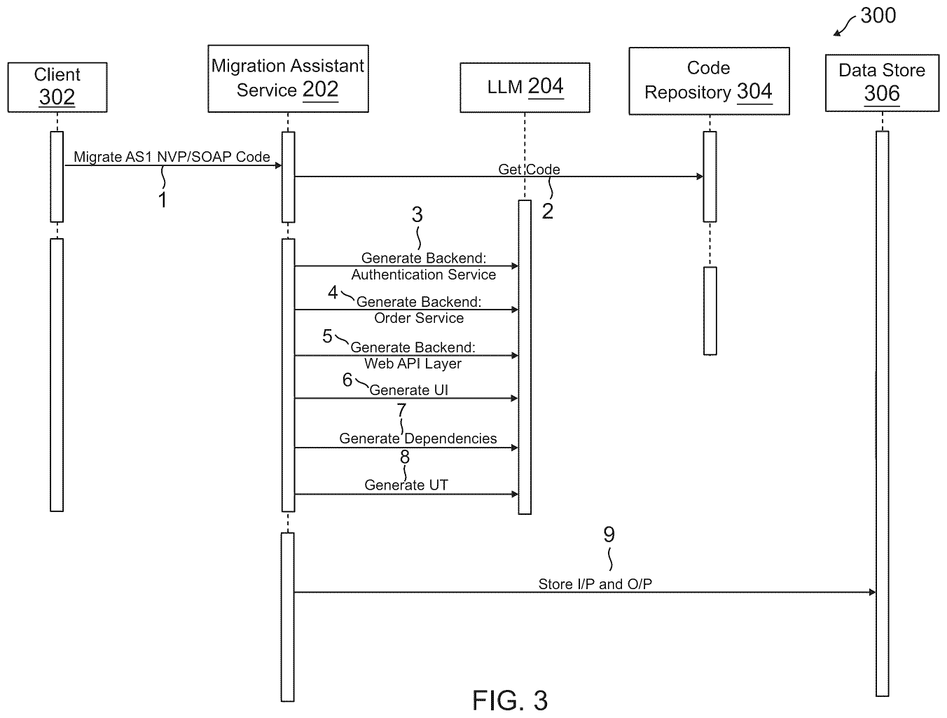

FIG. 3 is an exemplary diagram 300 of calls between different systems and services when generating code for computing service integration on a software platform using a large language model, according to various embodiments. Diagram 300 displays a set of calls 1-9 corresponding to the communications and data processing operations performed between devices, systems, and components shown in in system 100 of FIG. 1. For example, calls 1-9 may be performed during and/or based on the use of code integration platform 140 of service provider server 130 for integrations and migrations of computing service usages with software platforms. As such, diagram 300 represents a request from a client 302, such as developer device 120, of a merchant that may be processed to provide computing code for migrating computing code of the merchant's software platform to new APIs, although other types of integrations and corresponding computing code may similarly be generated using the calls and integrations shown in diagram 300.

As such, calls 1-9 may represent API calls between the different systems, components, applications, devices, and/or services shown in diagram 300. Calls 1-9 may be performed by code migration assistant service 202 when calling LLM 204 based on input 222 to generate output 224, as shown in system environment 200a. For example, calls 1-9 represent a set of API calls to an API of migration assistant service 202, LLM 204, code repository 304, and/or data store 306, which may be used for code generated. In particular, LLM 204 may be called to provide natural language and generative AI services for code generation. In this regard, calls 308 exchanged between code migration assistant service 202 and LLM 204 may be based on input 222, and LLM 204 may provide output 224 for the corresponding code generation.

Initially, client 302 interacts with migration assistant service 202, such as code integration platform 140, of a service provider via a call 1 to request migration of the software platform to usage of new APIs, such as from Simple Object Access Protocol (SOAP) APIs and code to Representational State Transfer (REST) APIs and code. Migration assistant service 202 may receive the request with a payload, such as legacy API code for the merchant's software platform with the SOAP APIs of the service provider and/or computing services. Migration assistant service 202 may utilize a call 2 to obtain code and code information, SDDs, and the like for the merchant's software platform and/or the APIs for prompting LLM 204 from a code repository 304. LLM 204 may correspond to an endpoint of an LLM and/or generative AI service, such as one that provides LLM 204 discussed in reference to FIGS. 2A and 2B. Code repository 304 may correspond to an online resource where computing code may be stored and accessible for testing, review, recoding, and/or implementing with different platforms.

During calls 3-8, migration assistant service 304 may then prompt LLM 204 in parts to obtain the different code sections necessary for migrating the computing code of the merchant's software platform to usage of the new APIs for the computing service. This may include executing or transmitting individual API calls, or sets of API calls (e.g., for a few-shot prompting approach with LLM 204) for each different code section to be generated by LLM 204 for the corresponding code integration. For example, LLM 204 may be prompted by migration assistant service 304 to generate computing code to integrate with APIs and/or execute API calls needed for a backend authentication service at a call 3, a backend order service at a call 4, a backend web API layer at a call 5, one or more UIs at a call 6, code dependencies at a call 7, and/or unit tests at a call 8.

For example, for call 3, authentication service code that adheres to the provided sample authentication code (e.g., for a specific authentication process and/or system), including the handling of the access token and the creation of a background process to check its validity, may be generated through the calls to LLM 204. For call 4, the migrated code for a particular “order” operation, such as a checkout and ordering operation for a merchant, or other executable operation using one or more APIs of the computing service and/or application may be generated. LLM 204 may generate code in response to call 4 that may create an order with the API for the ordering and/or checkout framework and HTTP requests. LLM 204, for call 5, may generate new or migrated code for the backed ordering and/or checkout system based on the provided context and mapping rules. For example, the migrated code for a checkout operation using the corresponding APIs may be generated and the code may use a library to make HTTP or other requests, as well as read the necessary environment variables for credentials. When proceeding to call 6 for UI code generation, LLM 204 may be called to generate UI code that integrates the SDK for the checkout process in one or more UIs. For example, the code may interact with the backend API endpoints set up and may create a checkout page or the like with an SDK script.

For call 7, LLM 204 may be prompted to generate a dependencies file for the code, such as a JSON package that includes all the dependencies needed for the backend code, such as dependencies on different components of the software system (e.g., libraries, frameworks, modules, APIs, services, etc.) that may be installed upon running the JSON package or the like. Finally, call 8 may request that LLM 204 generate unit tests, as well as any additional libraries for testing, of the code and dependencies generated by LLM 204 and/or utilized during code integration. As such, calls 3-8 may be performed to call LLM 204 by migration assistant service 202 in parts to generate the corresponding code section. This process may be performed in order to comply with the corresponding token limit of LLM 204, whereby the full code required for the integration may instead by generated in parts by calling LLM 204 to generate a code section corresponding to each of calls 3-8. This allows for generation of a specific section of code, which may be done while complying with the token limit of LLM 204, and the code sections may then be combined, stitched together, or otherwise packaged.

LLM 204 may respond with the corresponding code, which may be packaged into a data package and/or container. For example, migration assistant service 202 may combine, stitch together, or otherwise package each code section into a single code package or file that may be executable and/or utilized to integrate code and/or upgrade/migrate existing code for computing service usage on a merchant platform. Once packaged, migration assistant service 202 may then store the data package with a data store 306 for access, such as by storing the input/payload and the output/payload from prompting LLM 204 and receiving responses from the LLM 204 via a call 9. The merchant may then access data store 306 to obtain the code, as well as upload to a different platform and/or environment for review, testing, and the like.

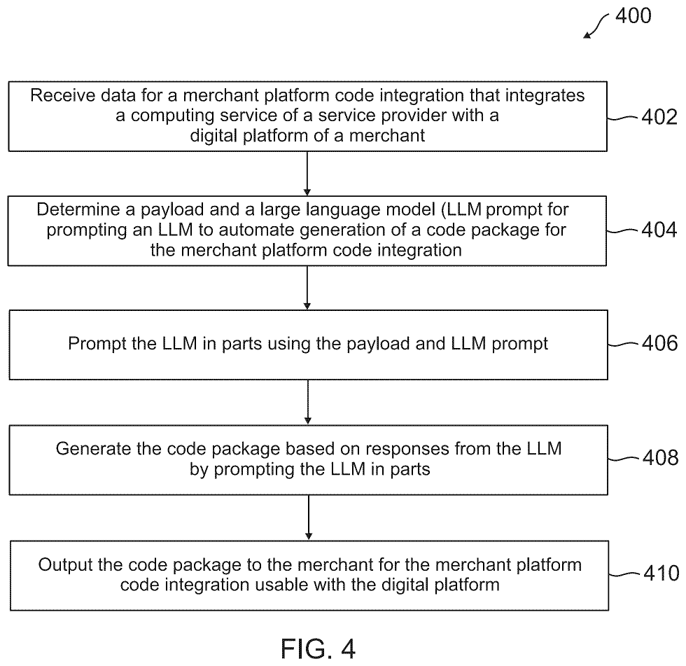

FIG. 4 is a flowchart 400 for automated code generation using large language models (LLMs) for software platform integrations with computing services, according to an embodiment. For example, flowchart 400 may be performed by code integration platform 140 based on code integration requests 141. In this regard, code integration platform 140 may receive a request from developer application 122 on developer device 120 to update merchant code 113 of merchant platform 112 on merchant server 110. This request may correspond to legacy code integrations 114a that are to be updated with new code 115b received from code integration platform 140 by prompting LLMs 145 to generate such code using one or more of payloads 142 and LLM prompts 144. Update of legacy code integrations 114a with new code 115b may facilitate the use of new APIs, endpoints, and other components of service applications 132 on service provider server 130 so that corresponding computing services may be provided through merchant platform 112. Note that one or more steps, processes, and methods described herein of flowchart 400 may be omitted, performed in a different sequence, or combined as desired or appropriate.

At step 402 of flowchart 400, data for a merchant platform code integration that integrates a computing service of a service provider with a digital platform of a merchant is received. For example, in system 100 of FIG. 1, merchant server 110 may integrate computing code for and/or migrate a previous integration of computing code for use of a computing service provided by service provider server 130 on merchant platform 112. As such, computing services of service provider server 130 may be provided on other separate and/or third-party platforms through code integrations provided intelligently using code integration platform 140. To integrate code, merchant software platform information, code, and/or other data set of merchant data, software platform data, code, and/or code requirements (e.g., capabilities, specifications, SDDs, etc.) may be provided for the merchant platform code integration. Service provider server 130 may receive such data as a request with data for an input to an LLM (and/or other AI models, as discussed above), where the LLM may be prompted to process the input and provide code recommendations, snippets, packages, files, written code changes, and/or other executable computing code and information for the code integrations and/or previous code integration migrations.

At step 404, a payload and an LLM prompt for prompting an LLM to automate generation of a code package for the merchant platform code integration is determined. In this regard, the data provided with the request for the code integration on merchant platform 112 may include information associated with merchant code 113 and/or code development documents for merchant platform 112 that allows for code to be written, developed, and/or generated for merchant platform 112 when integrating the computing services provided by service applications 132 with merchant platform 112. For example, this may include existing code and/or legacy code and code integrations, such as legacy API integrations and specifications used to call legacy APIs of the service provider (e.g., older and/or out-of-date APIs). The payload may include such source code, as well as SDDs, source code files, source code change logs and/or informational logs, sample code and/or code snippets, desired code formats and/or code specifications or configurations, API specifications and/or call structures or requirements, legacy code integrations and/or legacy code, and the like. As such, the payload may correspond to a set of data and/or samples the LLM may utilize for code generation.

An LLM prompt may be selected and configured or may be generated and/or provided for the specific request. The LLM prompt may correspond to one of multiple prompts, each prompt previously having been engineered for proper LLM instructing. For example, LLM prompts may be engineered based on instructions and data sets that were used to obtain proper responses from the LLM. A corresponding LLM prompt may be selected based on the merchant, request, code, computing service, and/or other parameter, and the LLM prompt may be updated or configured based on the payload and other input for the LLM. The LLM prompt may include the instructions, as well as a prompting strategy or set of calls to be executed for the prompting strategy, such as zero, one, and/or few-shot call prompting, question-and-answering prompting, chain-of-thought prompting, and the like.

At step 406, the LLM is prompted in parts using the payload and the LLM prompt. LLMs may have token limits, such as a limit on “tokens” or units of data including words, characters, sets of words/characters, phrases, and the like, which may limit the amount of input received and processed by an LLM at a time. Token limits may establish a character limit, for example, and/or other limit on data size, such as to allow for proper processing of data (e.g. within predetermined time limits and/or accuracy), avoid incoherent or misleading responses, and/or allow for proper vectorization and/or other processing of the text or other input (e.g. within predetermined distance or accuracy thresholds). In this regard, the input data may exceed a token limit, resulting in multiple tokens for different code sections and/or code to be generated or migrated to a new code environment, format, and/or the like. The multiple tokens may be of the same size or of different sizes.

For example, LLMs 145 may limit an amount or size of data that may be input and/or provided to LLMs 145 based on this token size limit. As such, tokens may be generated from payloads 142 for use with the token size limits and LLM prompts 144 to LLMs 145. Tokens from input data for merchant platform 112, such as payloads 142, may correspond to code for an authentication service, backend including order service and/or API service(s), one or more UIs, code dependencies on different resources or services, unit tests to verify other blocks of code, and the like. As such, one or more of LLM prompts 144 may be used to prompt the corresponding one of LLMs 145 with a token for each corresponding code section and/or code to be generated and/or updated for a code migration between services and to new code implementations. The LLM may then be prompted by calling the LLM for each prompt and/or token.

At step 408, the code package is generated based on responses from the LLM by prompting the LLM in parts. In this regard, source code for the code integration requested by the merchant, such as new code 115b for a new integration and/or migration to new code implementations and/or services, may be generated by the LLM. As the LLM may be prompted in part for different code section tokens based on token limits of the LLM, the LLM may provide multiple responses. As such, the code package may be generated by combining and/or stitching together the computing code provided by the LLM from the prompting into a code package. This code package therefore has new code for the code implementation and/or migration for the computing service of the service provider.

At step 410, the code package is output to the merchant for the merchant platform code integration usable with the digital platform. The code and/or code package may be pushed or sent to a selected computing system of the merchant, such as a test computing environment, a production computing environment, and/or a code repository platform. For example, the merchant may request to receive the code directly for review and/or testing. However, the code may also be pushed to a code repository platform where multiple users, such as code developers, may access for review and/or testing. Further, a test or production computing environment may receive the code for testing or implementation, respectively. For example, new code 115b may deploy the code with merchant code 113 for merchant platform 112. Thus, using the above-described systems and methods, a more convenient and personalized computing code onboarding and/or migration system is achieved. Merchants and other entities are provided with automated code generation processes that remove or limit the manual efforts for code development, simplifying processes and providing more streamlined, efficient, and optimized computing code for improved performance and usage of new computing configurations and resources. This allows for coordinated communications with merchants and merchant software platforms to facilitate the incorporation of computing code for different computing services on such platforms.

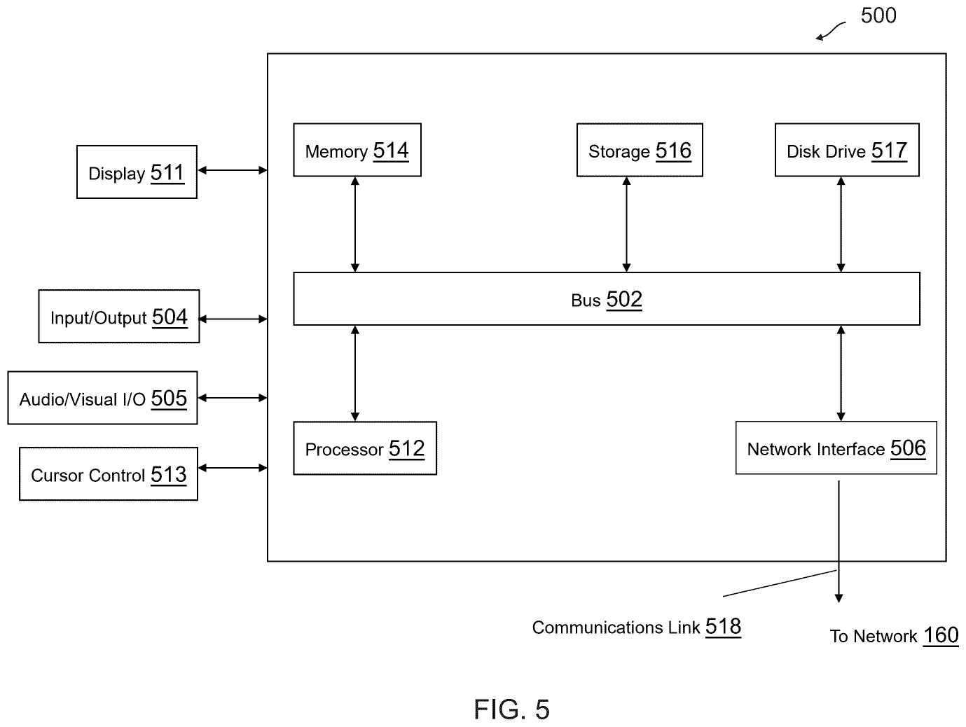

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions to cause the system to:
receive a request associated with integrating a software platform of a merchant with a computing service associated with a service provider, wherein the request comprises a payload associated with the software platform;
determine a large language model (LLM) prompt for an LLM configured to generate new code integrations with at least the computing service based on LLM training data associated with available code integrations for at least the computing service;
prompt the LLM to create a new code integration based on the LLM prompt and the payload;
receive the new code integration for the software platform from the LLM, wherein the new code integration comprises a code package of new code generated by the LLM for one or more uses of the computing service of the service provider via the software platform of the merchant; and
load the code package for the new code integration to a selected computing system designated by the merchant.

2. The system of claim 1, wherein the request comprises an update of existing code with a set of legacy application programming interfaces (APIs) previously used with the computing service to the new code for a set of current APIs for the computing service.

3. The system of claim 2, wherein the existing code comprises source code currently used by the software platform, wherein the payload comprises one or more code packages for the source code, and wherein the set of current APIs include one or more representational state transfer (REST) APIs.

4. The system of claim 1, wherein executing the instructions further causes the system to:
determine a software design document (SSD) for the software platform,
wherein the prompting is further based on the SSD.

5. The system of claim 1, wherein the LLM prompt comprises a plurality of LLM prompts, and wherein prompting the LLM is further based on each of the plurality of LLM prompts and a corresponding portion of the payload.

6. The system of claim 5, wherein prompting the LLM uses an orchestration layer of the system to prompt the LLM using each of the plurality of LLM prompts and the corresponding portion of the payload, and wherein the plurality of LLM prompts are associated with generating the new code for at least one of an authentication process, backend code, a backend API layer, a user interface, one or more user interface elements, or one or more application dependencies.

7. The system of claim 1, wherein the new code, when executed, integrates the computing service on the software platform of the merchant for use by one or more users via a website or an application of the merchant, and wherein the computing service comprises at least one of a user authentication service, a transaction processing service, or a digital account service.

8. The system of claim 1, wherein loading the code package comprises pushing the code package to the selected computing system designated by the merchant, and wherein the selected computing system comprises one of a test computing environment, a production computing environment, or a code repository platform.

9. The system of claim 1, wherein prompting the LLM is further based on sample code for at least one of the available code integrations.

10. A method comprising:
determining that a code integration with a computing service provided by a service provider is available for a computing platform;
determining a payload usable when prompting a large language model (LLM) for an automated generation of the code integration, wherein the LLM is configured to generate new code integrations with at least the computing service based on LLM training data associated with available code integrations for at least the computing service;
identifying an LLM prompt associated with the code integration and the LLM;
prompting the LLM based on the LLM prompt and the payload;
receiving, based on the prompting, a new code integration for the computing platform from the LLM, wherein the new code integration comprises a code package of new code for one or more uses of the computing service of the service provider via the computing platform; and
outputting the new code integration via a code integration deployment process for the code integration of the computing platform with the computing service.

11. The method of claim 10, wherein the LLM has a token limit corresponding to a data restriction for the prompting the LLM, and wherein the prompting the LLM is performed based on the token limit.

12. The method of claim 11, wherein the prompting the LLM comprises prompting the LLM in parts based on a plurality of calls executed to the LLM to adhere to the token limit.

13. The method of claim 12, wherein the prompting the LLM in parts uses different portions of the payload for each of the plurality of calls.

14. The method of claim 12, wherein the prompting in parts is performed based on different code sections for generation by the LLM for the new code.

15. The method of claim 10, wherein the payload comprises at least one of a legacy code integration of the computing service with the computing platform, a software design document (SSD) for the software platform, or one or more response payloads of API calls from the software platform.

16. The method of claim 10, wherein the new code implements the computing service externally on the computing platform and causes calls to be executed to the service provider for the computing service.

17. The method of claim 10, wherein outputting the new code integration comprises storing the new code with a code repository platform accessible by a plurality of users, and wherein the new code is testable and reviewable on the code repository platform.

18. The method of claim 10, wherein the prompting the LLM is further based on sample code previously used by at least one of the available code integrations.

19. A non-transitory machine-readable medium having stored thereon machine-readable instructions executable to cause a machine to perform operations comprising:
receiving a request for a use of a computing service of a service provider with a software platform of a merchant, wherein the request comprises computing code data associated with the software platform;
determining at least one large language model (LLM) prompt for an LLM configured to generate a new code integration of the computing service with different software platforms based on LLM training data associated with integrating code for the computing service with the different software platforms;
prompting the LLM based on the at least one LLM prompt and the computing code data;
receiving the new code integration for the software platform from the LLM, wherein the new code integration comprises new code generated by the LLM for the use of the computing service of the service provider via the software platform of the merchant; and
communicating the code package to the merchant.

20. The non-transitory machine-readable medium of claim 19, wherein the at least one LLM prompt is associated with a plurality of computing code tokens generated based on a maximum data size for LLM tokens processable by the LLM, and wherein the plurality of computing code tokens correspond to different code portions of the new code integration and corresponding data portions of the computing code data.
